(19) United States
(12) Patent Application Publication
(10) Pub. No.: US 2026/0102887 A1
(43) Pub. Date: Apr. 16, 2026

(54) METHOD AND TOOLING FOR DISMOUNTING A CASSETTE SEAL

(71) Applicant: VOLVO TRUCK CORPORATION, Göteborg (SE)

(72) Inventor: Raphael BOST, Toussieu (FR)

(73) Assignee: VOLVO TRUCK CORPORATION, Göteborg (SE)

(21) Appl. No.: 19/360,081

(22) Filed: Oct. 16, 2025

(30) Foreign Application Priority Data
Oct. 16, 2024 (EP) 24207049.8

(51) Int. Cl. B25B 27/00

(52) U.S. Cl. CPC B25B 27/0028

(57) ABSTRACT

A method and a tooling for dismounting a cassette seal having a radially inner ring mounted on a rotative shaft and a radially outer ring mounted in a receiving static bore is described. The method for dismounting the cassette seal includes a pressing step comprising displacing a first of the radially inner and outer rings with respect to its respective cylindrical support surface, along a first axial direction along the main axis; an extraction step, subsequent to the pressing step, comprising displacing the second of the radially inner and outer rings with respect to its respective cylindrical support surface, along a second axial direction opposite to the first axial direction along the main axis.

### TECHNICAL FIELD

The disclosure relates generally to method and tooling for dismounting a cassette seal. In particular aspects, the disclosure relates to the dismounting of a cassette seal having a radially inner ring mounted on a cylindrical support surface of a rotative shaft and a radially outer ring mounted in a cylindrical support surface of a receiving static bore. The disclosure can be applied to dismounting a cassette seal pertaining to systems on-board heavy-duty vehicles, such as trucks, buses, and construction equipment, among other vehicle types including boats, trains, etc…. An example of such systems, where cassette seals can be present, may be an internal combustion engine, an electric motor, a pump, a compressor, a gearbox, a drive shaft, etc…, where the system comprises at least one rotative shaft, rotative around a main axis with respect to a receiving static bore. In one application, the system is an internal combustion engine, such as reciprocating piston combustion engine, having a crankshaft which is rotative with respect to an engine casing, and where a cassette seal is provided having a radially inner ring mounted on a cylindrical support surface of the crankshaft and a radially outer ring mounted in a cylindrical support surface of a receiving static bore of the engine casing. Although the disclosure may be described with respect to a particular vehicle and/or with respect to a particular system, the disclosure is not restricted to any particular vehicle nor to any particular system.

### BACKGROUND

A cassette seal is a common sealing component used for achieving dynamic sealing between a rotative shaft and a receiving static bore with respect to which the shaft is rotatably mounted. A cassette seal allows high-quality sealing and, due to the provision of both a radially outer ring and a radially inner ring, where a sealing lip carried by one of the rings interacts with the other ring, without interacting directly with neither the shaft or the static receiving bore, also avoids any degradation of the shaft or of the static receiving bore. However, dismounting of a cassette feel is often difficult due in part to the presence of both an inner ring and an outer ring, which are usually both mounted with significant friction fit respectively on the shaft and in the static receiving bore. Various methods and tooling have already been proposed for performing the dismounting of the cassette seal without requiring the disassembly of the shaft. However, none of the existing methods all tooling are entirely satisfactory, with many of such methods and tools leading to a complete destruction of the cassette seal. Complete destruction of the cassette seal may be detrimental to a good analysis of the state of health of the sealing system.

### SUMMARY

According to a first aspect of the disclosure, it is disclosed a method for dismounting a cassette seal having a radially inner ring mounted on a cylindrical support surface of a rotative shaft and having a radially outer ring mounted in a cylindrical support surface of a receiving static bore, the rotative shaft being rotative around a main axis with respect to the receiving static bore and the radially inner ring being rotative around the main axis with respect to the radially outer ring, and wherein at least one of said radially inner and outer rings carries at least one elastomeric annular lip which is biased against a contact surface of the other of said radially inner and outer rings.

Such method may include at least:

a pressing step comprising displacing a first of said radially inner and outer rings with respect to its respective cylindrical support surface, along a first axial direction along the main axis;

an extraction step, subsequent to the pressing step, comprising displacing the second of said radially inner and outer rings with respect to its respective cylindrical support surface, along a second axial direction opposite to said first axial direction along the main axis.

The first aspect of the disclosure may seek to facilitate the dismounting of the cassette seal. A technical benefit may include providing, by the pressing state, easier access to the second of said radially inner and outer rings to perform the extraction step.

Optionally in some examples, including in at least one preferred example, the pressing step may comprise inserting a presser tool having a presser surface which is angularly spread over more than 180 degrees of angle around the main axis and which is engaged axially, along the first axial direction, while being radially received between, on the one hand, the support surface of the first of said radially inner and outer rings, and, on the other hand, the second of said radially inner and outer rings, and where the presser surface engages the first of said radially inner and outer rings to cause its displacement along the first axial direction with respect to its respective cylindrical support surface. A technical benefit may include such tool providing easy implementation of the pressing step, by applying a presser effort only on the first one of said radially inner and outer rings, and by reducing the risk of tilting of the said first one of the radially inner and outer rings during the presser step.

Optionally in some examples, including in at least one preferred example, the presser surface of the presser tool may be annular and continuous around the main axis. A technical benefit may include having a presser effort exerted on the first of said radially inner and outer rings which is aligned on the main axis, thereby further reducing the risk of tilting of the said first one of the radially inner and outer rings during the presser step.

Optionally in some examples, including in at least one preferred example, the extraction step may include inserting a gripping tool having a gripping surface which is angularly spread over more than 180 degrees of angle around the main axis and which is, in an engaging substep of the extraction step, engaged axially, along the first axial direction, while being radially received between, on the one hand, the support surface of the first of said radially inner and outer rings, and, on the other hand, the second of said radially inner and outer rings. In such an example, the extraction step may further include a retracting substep which is subsequent to the engaging substep, in which the gripping tool is retracted axially along the second axial direction, in which the gripping surface engages the second of said radially inner and outer rings, whereby the second of said radially inner and outer rings is displaced axially with respect to its respective cylindrical support surface, along the second axial direction. A technical benefit may include such tool providing easy implementation of the extraction step, also taking advantage of the prior displacement of the first of said radially inner and outer rings during the pressing step, such prior displacement providing easier access to the second of said radially inner and outer rings.

Optionally in some examples, including in at least one preferred example, in the retracting substep, the gripping tool is retracted axially along the second axial direction until the second of said radially inner and outer rings is removed from its respective cylindrical support surface. A technical benefit may include easy implementation of the full removal of the second of said radially inner and outer rings.

Optionally in some examples, including in at least one preferred example, the radially inner ring has an armature comprising at least an inner tubular portion and at least one externally oriented radial flange extending externally from the inner tubular portion, wherein the radially outer ring has an armature comprising at least an outer tubular portion and at least one internally oriented radial flange extending internally from the outer tubular portion, and wherein at least one of said armatures carries at least one elastomeric annular lip which is biased against a contact surface of the other of said armatures. A technical benefit may include using the radial flange of the armatures of at least one of the rings as a reliable effort bearing element for receiving the presser effort, respectively the extraction effort applied to the respective ring during the presser step or the extraction step.

Optionally in some examples, including in at least one preferred example, during the retracting substep in which the gripping tool is retracted axially along the second axial direction, the gripping surface may engage the radial flange of the armature of the second of said radially inner and outer rings. A technical benefit may include a reliable gripping effect of the gripping tool on the second of said radially inner and outer rings.

Optionally in some examples, including in at least one preferred example the radial flange of the armature of the first of said radially inner and outer rings may be offset axially along the first direction with respect to the radial flange of the armature of the second of said radially inner and outer rings. A technical benefit may include reducing the risk of interference between the two radial flanges during the pressing step and/or during the extraction step.

Optionally in some examples, including in at least one preferred example, the first of said radially inner and outer rings may be the radially outer ring and the second of said radially inner and outer rings is the radially inner ring.

Optionally in some examples, including in at least one preferred example, the receiving static bore may be a through hole in a transverse wall of a casing in which the rotative shaft is received, and wherein the cylindrical support surface of the rotative shaft may be located near an extremity of the shaft which extends axially through the through hole, outwardly of the casing. In such an application, a technical benefit of the method may include making it possible to remove the cassette seal without removing the shaft from the casing.

Optionally in some examples, including in at least one preferred example, the first direction may a direction turned axially inwardly with respect to the casing. A technical benefit may include that the second direction is thus turned away from the casing, which is favorable to an easy removal of the cassette seal outwardly of the casing, without necessitating access to the interior of the casing.

Optionally in some examples, including in at least one preferred example, in a removal step subsequent to the extraction step, the first one of said radially inner and outer rings is removed by extracting said ring along the second direction. A technical benefit may include the easy total removal of the cassette seal.

According to a second aspect of the disclosure, it is herein disclosed tooling for dismounting a cassette seal having an radially inner ring mounted on a cylindrical support surface of a rotative shaft and a radially outer ring mounted in a cylindrical support surface of a receiving static bore, the rotative shaft being rotative around a main axis with respect to the receiving stating bore and the radially inner ring being rotative around the main axis with respect to the outer ring, and wherein at least one of said radially inner and outer rings carries at least one elastomeric annular lip which is biased against a contact surface of the other of said radially inner and outer rings. The tooling may comprise a presser surface which is angularly spread over more than 180 degrees of angle around the main axis and which is configured for axially engaging the first of said radially inner and outer rings, along the first axial direction, while being radially received between, on the one hand, the support surface of the first of said radially inner and outer rings, and, on the other hand, the second of said radially inner and outer rings. The second aspect of the disclosure may seek to provide a reliable contact with the first of said radially inner and outer rings. A technical benefit may include providing tooling which facilitates the dismounting of the cassette seal by, in a first step, displacing only the first of said radially inner and outer rings, in a reliable way.

Optionally in some examples, including in at least one preferred example, the presser surface is annular and is continuous around the main axis. A technical benefit may include reducing the risk of tilting of the said first one of the radially inner and outer rings during the presser step when a presser effort is exerted by the presser surface on the first of said radially inner and outer rings.

Optionally in some examples, including in at least one preferred example, the presser surface is part of a presser tool. A technical benefit may include having a dedicated tool perfectly adapted to assisting in the dismounting of a cassette seal.

Optionally in some examples, including in at least one preferred example, the presser tool may comprise a base and a presser tube extending axially from the base, the presser surface being formed at a free end of the presser tube. A technical benefit may include providing an efficient presser tool which is both reliable and of low cost.

Optionally in some examples, including in at least one preferred example, the tooling may further comprise a gripping surface which is angularly spread over more than 180 degrees of angle around the main axis and which is configured to be engaged axially, along the first axial direction, while being radially received between, on the one hand, the support surface of the first of said radially inner and outer rings, and, on the other hand, the second of said radially inner and outer rings, and configured such that, when the gripping surface is retracted axially along the second axial direction, the gripping surface engages the second of said radially inner and outer rings. A technical benefit may include providing tooling which facilitates the dismounting of the cassette seal by, in a second step, displacing the second of said radially inner and outer rings, in a reliable way.

Optionally in some examples, including in at least one preferred example, the gripping surface is part of a gripping tool. A technical benefit may include providing a further dedicated tool perfectly adapted to assisting in the dismounting of a cassette seal.

Optionally in some examples, including in at least one preferred example, the gripping tool may comprise at least three gripping fingers, the gripping fingers being angularly spread over more than 180 degrees of angle around the main axis, which extend each axially, parallel to the main axis, at a same gripping circle radius distance from the main axis, and each gripping finger having a first axial extremity and a second axial extremity, the second axial extremity being secured to a base of the gripping tool and the first extremity forming a free end of the gripping finger, wherein the free end of gripping finger comprises an elemental gripping surface turned towards the second axial extremity. A technical benefit may include providing an efficient gripping tool which is both reliable and of low cost.

Optionally in some examples, including in at least one preferred example, the gripping tool may comprise a central threaded column, extending along the main axis, which is threaded through the base of the gripping tool. A technical benefit may include facilitating the extraction of the second of said radially inner and outer rings.

Optionally in some examples, including in at least one preferred example, presser tool and the gripping tool are two independent tools. A technical benefit may include providing tooling which is simple to produce and use.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a partial and schematic cutout view of an exemplary reciprocating piston internal combustion engine having a crankshaft cassette seal according to an example.

FIG. 2 is a view similar to that of FIG. 1, wherein some components of the internal combustion engine have been removed, providing direct access to the crankshaft extremity and to the cassette seal, according to an example.

FIG. 3 is a schematic perspective view showing only certain components of the internal combustion engine of FIGS. 1 and 2, including a front cover, a front extremity of the crankshaft, and a front cassette seal, as well as an example of a presser tool forming part of an exemplary tooling for dismounting of a cassette seal.

FIG. 4 is a schematic axial cutout of the elements shown in FIG. 3, before any dismounting, according to an example.

FIG. 5 is a schematic enlarged view of a portion of the elements shown in FIG. 4, showing a position of the presser tool during the performance of a pressing step of a method for dismounting a cassette seal, according to an example.

FIG. 6 is a schematic perspective view showing the same components of the internal combustion engine of FIGS. 1 and 2, after the pressing step of a method for dismounting cassette seal, as well as an example of a gripping tool forming part of an exemplary tooling for dismounting of a cassette seal.

FIG. 7 is perspective view of the gripping tool of FIG. 6, viewed along a different angle.

FIG. 8 is an axial cutout view of the gripping tool of FIG. 7.

FIG. 9 is a schematic axial cutout view showing a position of the gripping tool of FIGS. 6 to 8, during the performance of an extraction step of a method for dismounting a cassette seal, according to an example.

FIG. 10 is a partial view showing a further position of the gripping tool of FIGS. 6 to 9, during the performance of an extraction step of a method for dismounting a cassette seal, according to an example.

FIG. 11 is a schematic diagram illustrating some of the steps of a method for dismounting a cassette seal.

### DETAILED DESCRIPTION

The detailed description set forth below provides information and examples of the disclosed technology with sufficient detail to enable those skilled in the art to practice the disclosure.

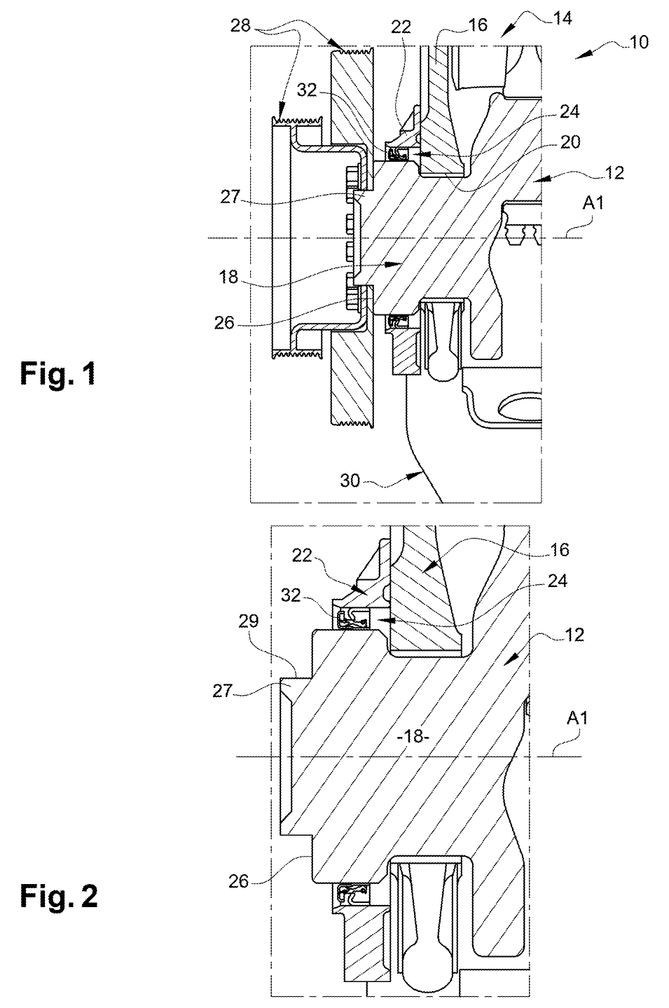

FIG. 1 is a partial view of an exemplary reciprocating piston internal combustion engine 10 having a crankshaft 12 which is rotative around its rotation axis A1, which will be hereinafter called main axis A1, inside an engine casing 14. Although not depicted in the figures, in the example of a reciprocating piston engine, the engine casing 14 encases the engine cylinders in which are found reciprocating pistons connected to the crankshaft 12 by connecting rods. The engine casing 14, often called engine block, comprises in this example a transverse wall 16 which is perpendicular to the main axis A1.

In FIG. 1, the transverse wall 16 may be called a front transverse wall for the engine casing 14, as opposed to a non-represented rear transverse wall of the casing 14, opposite to the front transverse wall 16 along the direction of the main axis A1. The engine casing 14 thus extends, along the direction of the main axis A1, from the front transverse walls 16 to the rear transverse wall (not shown). The notions of front and rear are used herein arbitrarily in a relative way, without constituting any limitation with respect to the engine’s implantation in its environment when in use. The notions of front and rear are used herein as a mere reference to a conventional implantation of an internal combustion engine in a heavy duty truck, where the engine 10 is mounted such that main axis A1 of its crankshaft is oriented parallel to the front to rear longitudinal axis of the vehicle, and where a front side of the engine faces the front of the vehicle and a rear side of the engine faces the rear side of the vehicle and may be connected to a transmission of a driveline. In the shown example, the main axis A1 exhibits a so-called first direction, which may in this example be from front to rear along said main axis A1, and a second direction, opposite to the first direction along the main axis A1, i.e. in the example from rear to front along the main axis A1.

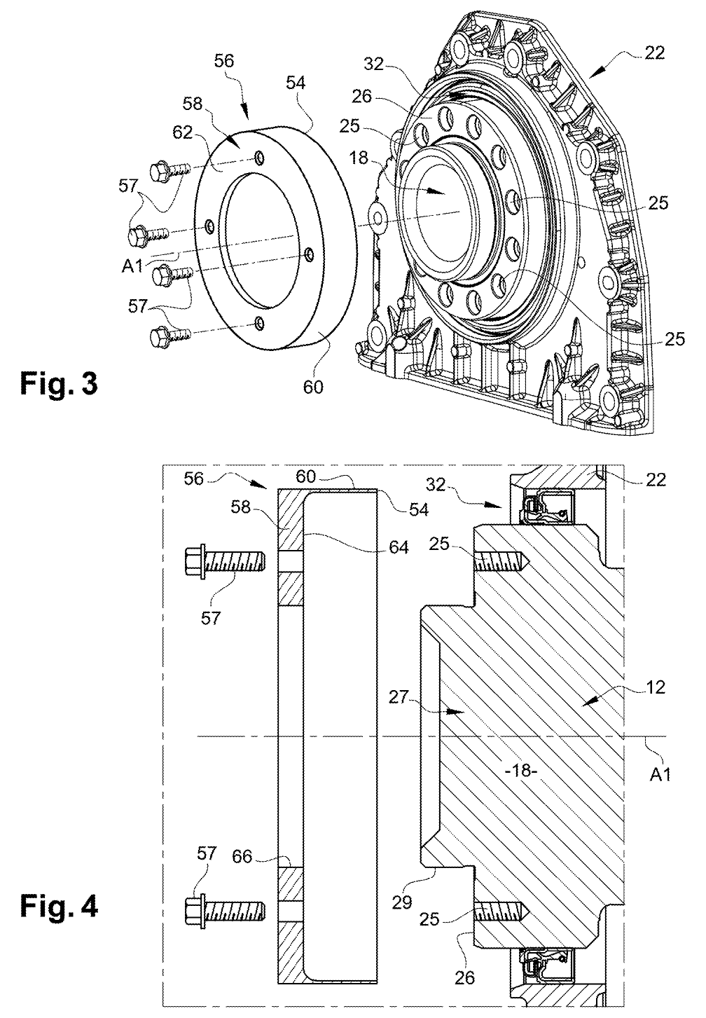

The crankshaft 12 extends along the main axis A1 in such a way that it exhibits at least a front extremity 18 which extends outside of the engine casing 14 through a corresponding aperture 20 in the front transverse wall 16. In the shown embodiment, the aperture 20 in the front transverse wall 16 forms a bearing for guiding the rotational movement of the crankshaft 12 with respect to the engine casing 14. A front cover 22 is affixed to an external surface of the front transverse wall 16, around the aperture 20 of the transverse wall 16, the front cover 22 having an aperture in the form of a cylindrical bore 24 which is coaxial with the main axis A and with the aperture 20 of the transverse wall 16. The front cover 22 covers the aperture 20. In the shown example, the front cover 22 is distinct from the front transverse wall 16 of the engine casing but is rigidly affixed thereto. In some examples, the front cover 22, including the cylindrical bore 24, may be partially or entirely made integral in one piece with the front transverse wall 16. The front extremity 18 of the crankshaft 12 extends through and past the cylindrical bore 24, so that a front transverse surface 26 of the front extremity 18 is located outside of the engine casing 14. In the example depicted on the figures, the front extremity 18 of the crankshaft may exhibits a nose portion 27 which extends axially towards the front in the center portion of the front transverse surface 26. As more clearly visible on FIG. 2, the nose portion 27 exhibits a cylindrical outer surface 29 around the main axis A1. In such a case, the front transverse surface 26 may exhibit an annular shape as clearly visible on FIG. 3.

In the shown example, a one or several drive pulleys 28 is/are mounted on the front transverse surface 26 of the front extremity 18 of the engine crankshaft. In a known manner, such drive pulleys 28 may be used to drive a pulley for transferring the rotary motion of the crankshaft 12 to internal components of the engine, such as one or several camshafts, and/or to other equipment and accessories of the engine, such as for example an oil pump, and/or a cooling fluid pump, and/or an electric generator, etc…. In the shown embodiment, the internal combustion engine 10 further comprises an engine oil pan 30 which is sealingly attached to the lower side of the engine casing 14 in such a way that the engine casing 14, including the front transverse wall 16 and the cover, and the engine oil pan 30 delimit together an interior volume of the engine casing 14. The crankshaft 12 thus extends primarily through the interior volume of the engine casing 14, but has at least its front extremity 18 which extends outside of the interior volume of the engine casing 14. As a consequence, to prevent or at least limit entry of contaminants such as water, mud or dust inside the internal volume of the engine casing 14, as well as for avoiding or limiting any exit of engine fluids, such as engine oil, outside of the interior volume of the engine casing 14, a crankshaft seal 32 is provided around the front extremity 18 of the crankshaft 12, which cooperates both with the front extremity 18 of the crankshaft 12 and with the cylindrical bore 24 in the front cover 22 of the engine casing 14. The crankshaft seal 32 is, in this example, formed of a cassette seal 32 to achieve a reliable fluid seal between the interior volume of the engine casing 14 and the exterior thereof.

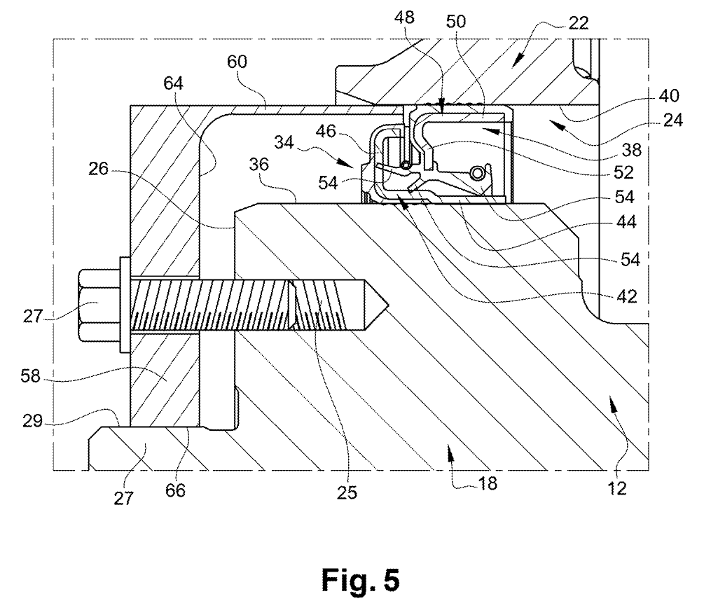

As most visible on FIG. 5, the cassette seal 32 comprises a radially inner ring 34 which is mounted on a cylindrical support surface 36 of the rotative shaft, here on the front extremity 18 of the crankshaft 12, and the cassette seal 32 further comprises a radially outer ring 38 mounted in a cylindrical support surface 40 of the receiving static bore 24 which, in this example, is formed in the front cover 22. Preferably, the support surface 36 pertaining to the shaft 12, and the support surface 40 pertaining to the receiving cylindrical bore 24, face each other in a radial direction, at least along a portion of their length along the main axis A1 where the cassette seal 32 is to be located.

In some examples, including the depicted example, the radially inner ring 34 may, as more clearly visible on FIG. 5, comprise an armature 42 comprising at least an inner tubular portion 44, parallel to the support surface 36, and at least one externally oriented radial flange 46 extending radially externally from the inner tubular portion 44. Similarly, the radially outer ring 38 may comprise an armature 48 comprising at least an outer tubular portion 50, parallel to the support surface 40, and at least one internally oriented radial flange 52 extending radially internally from the outer tubular portion 50. Each armature 42, 48 is made of a material and exhibits a geometry such that the armature 42, 48 withstands the mounting efforts and the operating efforts which are normally applied to the cassette seal 32 without substantial deformation. Each armature 42, 48 may for example be made of metal. Each armature 42, 48 is preferably at least in part covered by one or several layers of coating material, which may comprise elastomeric material, for protecting the armature, and/or for increasing the fluid tightness of the contact of the radially inner or outer ring 34, 38 on its corresponding support surface 36, 40.

In the cassette seal 32, at least one of said armatures 34, 38 carries at least one elastomeric annular lip 54 which is biased against a contact surface of the other of said armatures 36, 40. Typically, the cassette seal 32 may comprise one, two, three or more elastomeric annular lips 54 for achieving an optimum fluid-tightness between an interior side and an exterior side of the cassette seal 32. In a cassette seal construction, an elastomeric annular lip 54 preferably bears against a contact surface of the armature of the other ring, rather than directly bearing against the shaft 12 or the receiving static bore 24. This avoids or limits degradation of the shaft 12 or of the receiving static bore 24 which may be otherwise incurred due to the friction of the annular lip 54, when the shaft 12 rotates with respect to the static receiving bore 24.

As in many conventional designs of a cassette seal, the radial flange 46, 52 of the armature of a first of said radially inner and outer rings 34, 38 is offset axially along the first direction with respect to the radial flange of the armature of the second of said radially inner and outer rings. In the shown embodiment, the radial flange 52 of the armature 48 of the radially outer ring 38 is offset axially, along the first direction of the main axis A1, with respect to the radial flange 46 of the armature 42 of the radially inner ring 34. The radial dimension of the radially inner ring 34, and thus the radial dimension of the radial flange 46, is less than the radial clearance between the support surface 36 of the shaft 12 and the support surface 40 of the receiving cylindrical bore 24, where those support surfaces 36, 40 face each other in a radial direction. The radial dimension of the radially outer ring 38, and thus the radial dimension of the radial flange 52, is less than the radial clearance between the support surface 36 pertaining to the shaft 12 and the support surface 40 pertaining to the receiving cylindrical bore 24, where those support surfaces 36, 40 face each other in a radial direction. In other words, a radial clearance is available between the radially inner ring 34 and the support surface 40 pertaining to the receiving cylindrical bore 24. Conversely, a radial clearance is available between the radially outer ring 38 and the support surface 36 pertaining to the front extremity 18 of the shaft 12.

In a conventional manner, the cassette seal 32 is press fits both on the front extremity 18 of the shaft 12 and in the receiving cylindrical bore 24 of the transverse wall 16 of the engine casing 14. That is to say that, in most cases, the longitudinal position of the cassette seal 32 both on the shaft of 12 and in the row receiving cylindrical bore 24 is ensured primarily by friction between the respective radially inner and outer rings and their respective support surfaces 36, 40. Such friction fit also contributes to fluid tightness of the cassette seal 32. This of course does not rule out the possible provision of additional blocking or locking means, such as an abutment surface formed either on the front extremity 18 of the shaft 12 and/or in the receiving cylindrical bore 24, and/or such as an elastic retaining ring. On the other hand, such friction fit makes the dismounting of the cassette seal difficult due to the fact that the cassette seal is usually not easily accessible, except from a front transverse face thereof, when it is mounted on the shaft 12 as assembled in the engine casing 14.

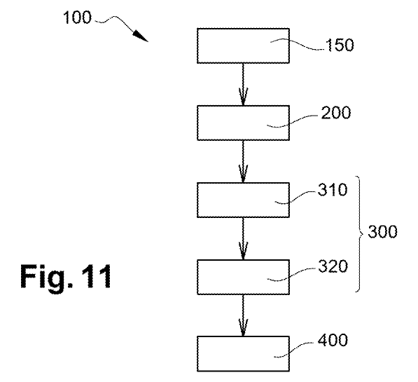

Therefore, it is herein disclosed a method for dismounting said cassette seal 32, which does not necessitate removing the crankshaft 12 from the engine casing 14. A flowchart at FIG. 11 illustrates some of the steps of such method.

According to one aspect, a method 100 for dismounting said cassette seal may include at least:

a pressing step 200, comprising displacing a first of said radially inner and outer rings 34, 38 with respect to its respective cylindrical support surface 36, 40, along a first axial direction along the main axis A1;

an extraction step 300, subsequent to the pressing step 200, comprising displacing the second of said radially inner and outer rings 34, 38 with respect to its respective cylindrical support surface 36, 40, along a second axial direction opposite to said first axial direction along the main axis.

Thanks to the pressing step 200, which comprises displacing one of the rings 34, 38 along the first axial direction, the other of said two rings 34, 38 becomes more easily accessible via the radial clearance between that other ring and the support surface for the first ring, wherein said the support surface faces the second ring and belongs either to the shaft 12 or to the receiving cylindrical bore 24.

Typically, the first direction, along which the first one of the rings 34, 38 is displaced during the pressing step 200 of the method, is not the direction along which the cassette seal 32 is to be dismounted as a whole. Rather, this pressing step tends to displace the first one of said rings 34, 38 in the opposite direction with respect to its final dismounting direction. However, this first displacement of the first of said radially inner and outer rings 34, 38 enables a better access to the second of said radially inner and outer rings34, 38, allowing an easier extraction of said second ring 34, 38 during the extraction step 300. In a subsequent removal step 400, after the second of said radially inner and outer rings 34, 38 has been extracted, it is then easier to remove the first one of said rings 34, 38, for example by extracting said first one of said rings 34, 38 along the second direction.

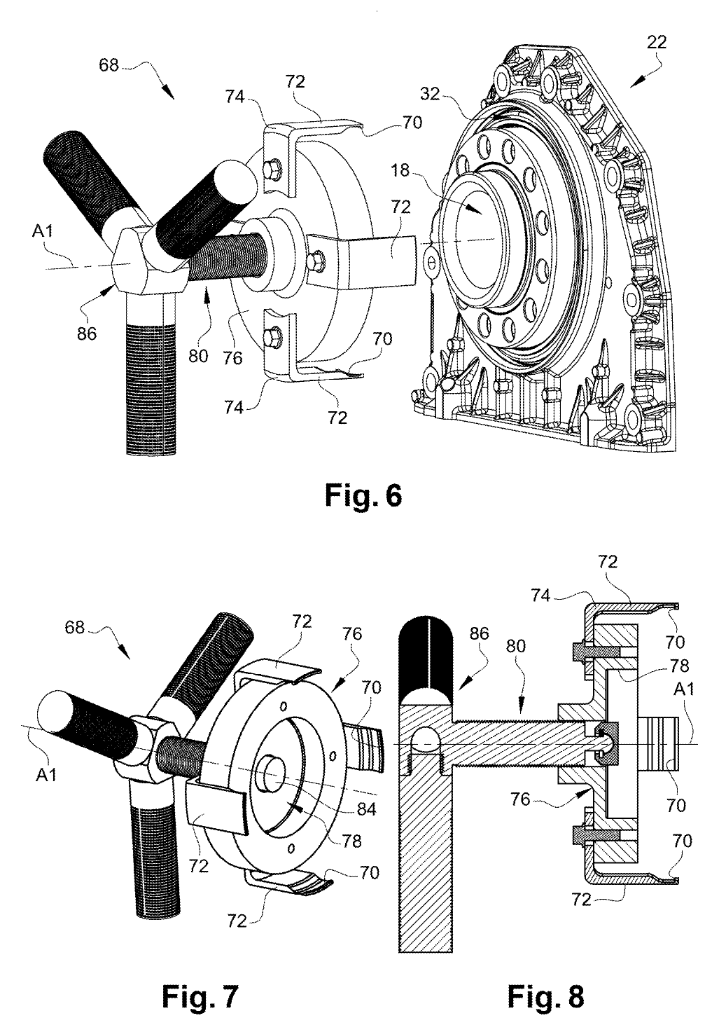

In some embodiments of such a method, including the embodiments described in FIGS. 1 to 10, the first of said radially inner and outer rings is the radially outer ring 38, which is displaced along the first axial direction during the pressing step 200, and the second of said radially inner and outer rings is the radially inner ring 34 which, in the extraction step 300, is displaced along a second axial direction opposite to said first actual direction along the main axis A1.

In some embodiments of the invention, such as in the case described above of a crankshaft cassette seal 32, the first direction is a direction turned axially inwardly with respect to the engine casing 14.

The amount of displacement of the first one of said rings 34, 38 along the first direction during the pressing step 200 of the method may be in the order of magnitude of the axial length of the cassette seal 32. For example, during the pressing step 200 of the method, the first one of said radially inner or outer rings 34, 38 may be displaced, along the first direction, by an amount which is for example of comprised between 20% and 200% of the total axial length of the cassette seal 32 when it is in its use configuration.

In some embodiments, the method may be implemented using dedicated tooling.

In some embodiments, for carrying out the pressing step 200 of the method, the tooling may comprise a presser surface 54 which is angularly spread over more than 180 degrees of angle around the main axis A1 and which is configured for axially engaging the first of said radially inner and outer rings 34, 38, along the first axial direction, while being radially received between, on the one hand, the support surface 36, 40 of the first of said radially inner and outer rings 34, 38, and, on the other hand, the second of said radially inner and outer rings 34, 38.

An example of such tooling is visible more particularly in FIGS. 3 to 5. In those figures is shown an example of a presser tool 56 having such a presser surface 54.

In those examples, the presser surface 54 is annular and is continuous around the main axis A1, preferably continuous over the 360 degrees of angle around the main axis A1, thus continuous over a full circle around main axis A1. However, the presser surface could be discontinuous. It could be formed of several elemental presser surfaces, separate one from the other and angularly spaced one from the other around the main axis A1.

The presser surface 54 being angularly spread over more than 180 degrees of angle around the main axis A1 ensures that the pressing force exerted by the presser surface 54 on the first of said radially inner and outer rings 34, 38, is not acting on only one side of said ring with respect to the main axis A1. This ensures that the first of said radially inner and outer rings 34, 38 does not tilt during the pressing step 200.

Preferably, the presser surface 54 is such that its centroid is aligned on the main axis A1, so that the pressing action of the presser surface 54 on the first of said radially inner and outer rings 34, 38 is perfectly balanced around the main axis A1, thereby minimizing any risk of tilting of the first of said radially inner and outer rings 34, 38 during the pressing step 200.

Preferably, the presser surface 54 is contained in a single plane. In use of the presser tool 56, the single plane containing the presser surface 54, in the sense of the annular and continuous presser surface as shown in FIGS. 3 to 5, and/or in the sense of the multiple element presser surfaces of a discontinuous presser surface, is perpendicular to the main axis A1. Thanks to such feature, and in combination with the fact that the presser surface 54 is spread over more than 180° of angle around the main axis A1, the presser surface 54 may exert on the corresponding radially inner or outer ring, a resulting force which is axially aligned with the main axis A1. Such alignment minimizes the risk of the corresponding radially inner or outer ring 34, 38 tilting with respect to the main axis A1.

In some embodiments, as in the example depicted in FIGS. 3 to 5, the presser tool 56 may comprise a base 58 and a presser tube 60 extending axially from the base 58. In such a design, the presser surface 56 may be formed at a free end of the presser tube 60.

In the example, the base 58 comprises an annular plate which is annular around the main axis A1 and which has two opposites side faces, including a front annular face 62 and the rear annular face 64, which are perpendicular to the main axis A1. However, the base 58 may have a different shape, especially regarding its front face.

The rear annular face 64 of the base 58 is configured to come in abutment with the front transverse surface 26 of the front extremity 18 of the shaft 12.

In this example, the base 58 exhibits a central cylindrical aperture 66 having a diameter equal or greater than a diameter of the cylindrical outer surface 29 of the central nose portion 27 of the front extremity 18 of the shaft 12, so that said central nose portion 27 may be accommodated in the central cylindrical aperture 66 when the rear annular face 64 of the base 58 is pressed into contact with the front transverse surface 26. Preferably, the diameter of the central cylindrical aperture 66 is equal to the diameter of the cylindrical outer surface 29 of the central nose portion 27, so as to provide a centering effect when inserting the presser tool 56 axially on the front extremity 18 of the shaft 12. This ensures proper alignment of the presser surface 54 with the clearance between, in this example, the support surface 40 of radially outer ring 38 and the radially inner ring 34, so as to engage with, in the example, the radially outer ring 38.

The presser tube 60 extends axially in the first direction from the base 58. In the shown example, the presser tube 60 extends axially towards the rear from the base 58. In the example, the presser tube 60, which is cylindrical around the main axis A1, extends from the peripheral portion of the base 58 and thus extends around the rear annular face 64.

The presser tube 60, and thus the presser surface 56, has an external diameter which is inferior to the diameter of the support surface 40 of the receiving cylindrical bore 24. The presser tube 60, and thus the presser surface 56, has an internal diameter which is superior to the diameter of the radially inner ring 34. Therefore, as can be seen in FIG. 5, the presser tube 60 and the presser surface 56 may be inserted along an axial direction in a clearance between the support surface 40 of the receiving cylindrical bore 24 and the radially inner ring 34. By doing so, the presser surface 56 may be brought into contact with the radially outer ring 38, along the presser surface 54 which acts as a contact surface, and without engaging the radially inner ring 34.

As can be seen in FIG. 1, the cassette seal 32 may, in most cases, not be accessible when the engine 10 is fully mounted and operational. For example, in the example of FIG. 1, at least the drive pulleys 28 prevent any access to the crankshaft cassette seal 32. In FIGS. 2 and 3, it is illustrated that it may suffice to, in an initial step 150 of the method, remove some auxiliary equipment from the engine environment, such as, in the example, to remove the drive pulleys 28, in order to gain sufficient access to the cassette seal 32.

Once the cassette seal 32 is accessible along an axial direction from the exterior, in the depicted example from the exterior of the engine casing 14, the pressing step 200 of the method may be implemented. The pressing step 200 includes inserting the presser tool 56 in such a way that the presser surface 54, which is angularly spread over more than 180 degrees of angle around the main axis A1, is engaged axially, along the first axial direction along the main axis A1 towards the cassette seal 32. During such axial engagement, the presser surface 54, and thus the free end of the presser tube 60, is radially received between, on the one hand, the support surface of the first of said radially inner and outer rings, and, on the other hand, the second of said radially inner and outer rings. After some amount of engagement along the first direction, the presser surface 54 engages the first of said radially inner and outer rings 34, 38 to cause its displacement along the first axial direction with respect to its respective cylindrical support surface 36, 40. In the embodiment depicted in the figures the presser surface 54 of the presser tube 60 engages the radially outer ring 38, which is therefore, in this example, said first one of said radially inner and outer rings. Once the presser surface 54 is engaged with the radially outer ring 38, the presser tool 56 continues its displacement along the first axial direction and therefore presses the radially outer ring 38 and causes its displacement, along the first axial direction, with respect to its cylindrical support surface 40 in the receiving cylindrical bore 24. Although not depicted in the figures, such displacement may be for example continued until the front annular face 62 of the base 58 of the presser tool 60 comes into abutment along the axial direction against the front transverse surface 26 of the front extremity 18 of the shaft 12.

The displacement of the presser tool 54 may be manual or may be performed through further elements of the tooling. For the example, the tooling may comprise an actuator, such as a mechanical, electric or pneumatic jack, to displace the presser tool 56 along the main axis in the first direction. In the depicted example, the tooling comprises a series of bolts 57 which are axially received through through-holes in the base 58 of the presser tool and which are screwed into corresponding threaded holes 25 formed in the front transverse surface 26 of the front extremity 18 of the shaft 12. When tightened, the bolts 57 press the presser tool 56 axially in the first direction with respect to the shaft 12. Preferably, the bolts 57 and the corresponding threaded holes 25 are arranged at equal angular intervals around the main axis A1. For example, the threaded holes 25 formed in the front transverse surface 26 of the front extremity 18 of the shaft 12 may be those holes which, in a use configuration of the engine 10, are used for securing the one or several drive pulleys 28.

Preferably, during the pressing step 200 of the method, the second of said radially inner and outer rings, i.e. the radially inner ring 34 in the depicted example, is not displaced neither with respect to the front extremity 18 of the shaft 12 nor with respect to the engine casing 14, at least not in any substantial amount. Thus, during the pressing step 200 of the method, the first of said radially inner and outer rings 34, 38 is displaced with respect to the second of said radially inner and outer rings, along the first direction, by an amount which is preferably equal or substantially equal to the amount of displacement the first of said radially inner and outer rings 34, 38 with respect to its respective support surface 36, 40.

Once the first one of the radially inner and outer rings 34, 38 has been displaced, the extraction step 300 may be implemented.

The extraction step 300 may include inserting a gripping surface 70 which is angularly spread over more than 180 degrees of angle around the main axis A1, between, on the one hand, the support surface 36, 40 of the first of said radially inner and outer rings 34, 38, and, on the other hand, the first of said radially inner and outer rings 34, 38. In other words, the gripping surface 70 is inserted in the same annular space as the one in which the presser surface is inserted during the presser step

In those examples, the gripping surface 70 is discontinuous. It can be formed of several elemental gripping surfaces 70, separate one from the other, and angularly spaced one from the other around the main axis A1, preferably angularly spaced at equal intervals over the 360 degrees of angle around the main axis A1.

The gripping surface 70 being angularly spread over more than 180 degrees of angle around the main axis A1 ensures that the gripping force exerted by the gripping surface 70 on the second of said radially inner and outer rings 34, 38, is not acting on only one side of said ring with respect to the main axis A1. This ensures that the second of said radially inner and outer rings 34, 38 does not tilt during the extraction step 300.

Preferably, the gripping surface 70 is such that its centroid is aligned on the main axis A1, so that the gripping action of the gripping surface 70 on the second of said radially inner and outer rings 34, 38 is perfectly balanced around the main axis A1, thereby minimizing any risk of tilting of the second of said radially inner and outer rings 34, 38 during the extraction step.

In the depicted example, the gripping surface 70 is part of a gripping tool 68. In the depicted example, the presser tool 56 and the gripping tool 68 are two independent tools.

As an example, the gripping tool 68 may comprise at least three gripping fingers 72. The gripping fingers are angularly spread over more than 180 degrees of angle around the main axis A1. Preferably, the gripping fingers 72 are identical and are spaced at equal angular intervals one from the other around the main axis A1. In the example, the gripping tool 68 comprises four gripping fingers 72 arranged at 90 degrees of angle one from the other around the main axis A1. In other examples, non-depicted, the gripping tool could comprise three gripping fingers arranged at 120 degrees, or five fingers arranged at 72 degrees, or six gripping fingers arranged at 60 degrees, etc…. In some examples, each finger 72 has an angular width or extension around the main axis A1 which is for example comprised between 5 and 45 degrees of angle around the main axis A1, preferably comprises between 10 and 30 degrees of angle around the main axis A1.

In some embodiment, such as the one depicted, each gripping finger 72 extends axially, parallel to the main axis A1, at a same gripping circle radius distance R from the main axis A1. The gripping circle radius distance R is such that the gripping finger 72 initially faces the clearance between, on the one hand, the support surface 36, 40 of the first of said radially inner and outer rings 34, 38, and, on the other hand, the second of said radially inner and outer rings 34, 38.

Each gripping finger 72 has a first axial extremity and a second axial extremity 74, the second axial extremity being secured to a base 76 of the gripping tool 68. The second axial extremity may be in the form of a radially extending flange 75 which may be secured to the base 76, for example by one or more bolts, by welding, etc... In other non-depicted embodiments, the gripping fingers 72 could be integral with the base 76, being thus joined with the base at their second axial extremity 84. The first extremity forms a free end of the gripping finger 72. Each gripping finger 72 extends axially in the first direction from its second axial extremity 74 to its free end formed by its first extremity. The free end of each gripping finger 72 comprises an elemental gripping surface 70 turned towards the second axial extremity 74. The elemental gripping surfaces 70 of the gripping fingers 72 form collectively the gripping surface 70 of the gripping tool 68. For example, the gripping surface 70 of each gripping finger may be in the shape of a hook portion. In the example, where the gripping surface is configured to engage the radially inner ring 34 from its outer diameter, the hook portion forming the gripping surface is turned radially inwardly.

In some examples, including the depicted example, the gripping circle radius distance R of the gripping surface 70 may be adjustable. In some examples, including the depicted example, at least one of the gripping fingers 72, preferably several of the gripping fingers, most preferably all of the gripping fingers, may have a position which is radially adjustable with respect to the main axis A1. In the example, each gripping finger 72 is secured to the base 76 by a bolt 73 which extends through a through-hole 77 in the radially extending flange 75, and is screwed in a correspond threaded hole 79 in the base 76. To achieve radial adjustability of the gripping finger 72, the through-hole 77 may be elongated along the radial direction.

In an engaging substep 310 of the extraction step 300, the gripping surface 70 is engaged axially, along the first axial direction, while being radially received between, on the one hand, the support surface 36, 40 of the first of said radially inner and outer rings 34, 38, and, on the other hand, the second of said radially inner and outer rings 34, 38. In the example, during the engaging substep 310, the gripping surface 70 is engaged axially, along the first axial direction, while being radially received between, on the one hand, the support surface 40 of radially outer ring 38, and, on the other hand, the radially inner ring 34.

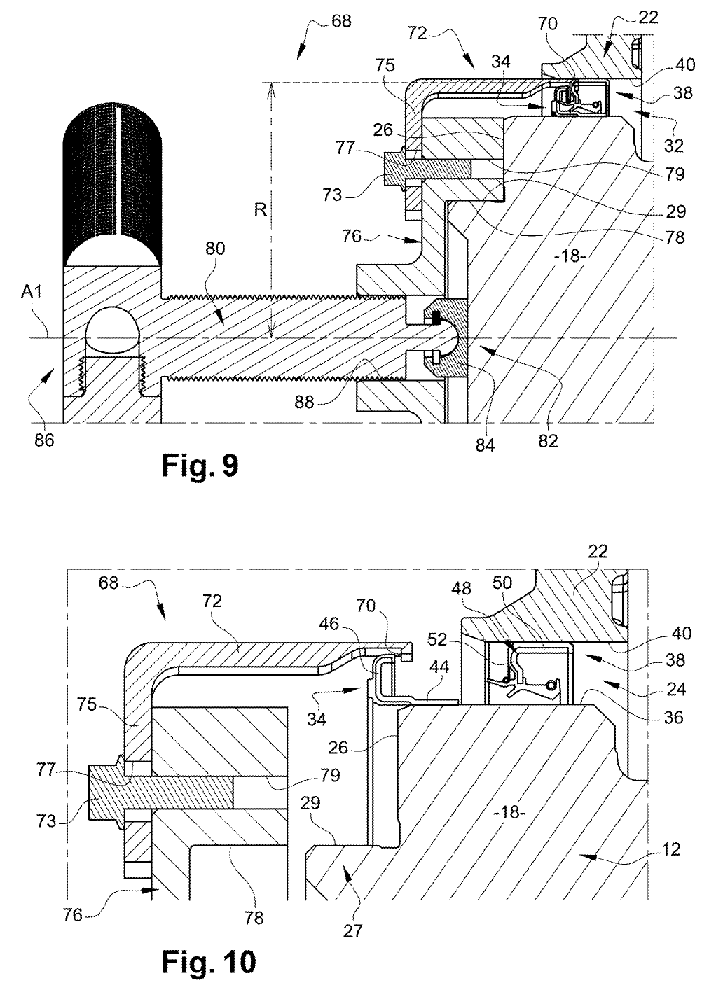

In some example, the base 76 of the gripping tool 74 may exhibit a central cylindrical cavity 78, opened toward the first direction, and having a diameter equal or greater than the diameter of the cylindrical outer surface 29 of the central nose portion 27 of the front extremity 18 of the shaft 12, so that said central nose portion 27 may be accommodated in the central cylindrical cavity 78. Preferably, as shown on FIG. 9, the diameter of the central cylindrical cavity 78 is equal to the diameter of the cylindrical outer surface 29 of the central nose portion 27, so as to provide a centering effect when inserting the gripping tool 68 axially on the front extremity 18 of the shaft 12. This ensures proper alignment of the gripping fingers 72 with the clearance between the support surface 40 of radially outer ring 38 and the radially inner ring 34.

At the end of the engaging substep 310, the gripping surface 70 has been, axially in the first direction, engaged past the radial armature of the second of said radially inner and outer rings 34, 38, i.e., in the depicted example, past the radial flange 46 of the radially inner ring 34, as shown in FIG. 9. In that position, the base 76 of the gripping tool 68 may be axially in abutment against the front extremity 18 of the shaft 12, for example against its front transverse surface 26. During the engaging substep, the gripping surface 70 may be required to flex radially to get axially past the radial armature of the second of said radially inner and outer rings 34, 38, preferably without causing any substantial damage to said second of radially inner and outer rings 34, 38. The gripping surface 70 therefore hooks on the radial armature of the second of said radially inner and outer rings 34, 38.

After the engaging substep 310, the extraction step 300 includes a retracting substep 320 in which the gripping tool 68 is retracted axially along the second axial direction. In such retracting substep 320, the gripping surface 70 engages the second of said radially inner and outer rings 34, 38, i.e., in the depicted example, the radially inner ring 34. In the depicted example, the gripping surface 70 engages the radial flange 46 of the radially inner ring 34. Thereby, as the gripping tool 68 is retracted axially along the second axial direction, the second of said radially inner and outer rings 34, 38 is displaced axially with respect to its respective cylindrical support surface, along the second axial direction.

Preferably, during the retracting substep 310, the gripping tool 68 is retracted axially along the second axial direction until the second of said radially inner and outer rings is removed from its respective cylindrical support surface.

The displacement of the gripping tool 68 during the engaging substep 310 and/or during the retracting substep 310 may be manual or may be performed through further elements of the tooling.

For the example, the tooling may comprise an actuator, such as a mechanical, electric or pneumatic linear actuator, to displace the gripping tool 56 along the main axis A1, in the first direction during the engaging substep 310 and/or during the second direction during the retracting substep 310.

In the depicted example, the gripping tool comprises a central threaded column 80, which extends along the main axis A1 and which is threaded through the base 78 of the gripping tool 68.

The central threaded column 80 has a first axial end 82 which extends on the first side of the base 76, i.e. on the rear side of the base 76 in the depicted example, and which is configured to abut axially against the axial extremity of the shaft 12, here against the nose portion 27 of the first extremity 18 of the shaft 12. The first axial end 82 may be equipped with a rotary contact pad 84 configured to freely rotate with respect to the central threaded column 80, so as to lower the amount of contact friction when the central threaded column 80 is rotated around its main axis A1 while abutting against the axial extremity of the shaft 12.

The central threaded column 80 has a second axial end 86 which extends on the second side of the base 76, i.e. on the front side of the base 76 in the depicted example, and which is configured to receive an input rotational drive movement to cause the central threaded column 80 to rotate around its main axis A1. In the depicted example, the central threaded column 80 is to be manually driven. Therefore, the second axial end 86 may be configured as a knob, for example as spoked knob comprising radial spokes, to allow for an easily manual rotation of the central threaded column 80. In other examples, non-depicted, the second axial end may be configured for connection to a rotary actuator.

The middle portion of central threaded column 80, in between the first axial end 82 and the second axial end 86, is threaded and screwed into a threaded through hole 88 of the base 76 of the gripping tool 68. When rotated in the correct direction, the central threaded column 80 causes the first axial end 82 to abut axially against the shaft 12 while the base is displaced axially in the second direction, away from the first axial end 82, and thus axially away in the second direction from the shaft 12. The gripping surface 70 which is secured to the base 76 follows the same movement, and, thanks to its engagement with the second of said radially inner and outer rings 34, 38, i.e., in the depicted example, the radially inner ring 34, causes the retraction of the second of said radially inner and outer rings 34, 38 in the second direction, as shown in FIG. 10. Thereby, in this example, the central threaded column 80 may be used to cause a displacement of the gripping tool in the second axial direction during the retracting substep 310.

When the second of said radially inner and outer rings 34, 38, i.e. the radially inner ring 34 in the example, has been dismounted from shaft, the first one of said radially inner and outer rings 34, 38, i.e. the radially outer ring 38 in the example, is more easily accessible. Indeed, removal of the second of said radially inner and outer rings 34, 38 provides access to a clearance between the first one of said radially inner and outer rings 34, 38 and the facing support surface, i.e. the support surface 36 of shaft 12 in the example. By acceding to such clearance, any tool may be used to remove the first one of said radially inner and outer rings 34, 38. In many cases, a simple tool may be sufficient to remove the first one of said radially inner and outer rings 34, 38. It is to be noted that, in the example as described above, where the first one of said radially inner and outer rings 34, 38 is mounted in a front cover 22 which may be detached from the rest of the engine casing, the front cover may be detached to totally remove the cassette seal from the shaft 12, and the first one of said radially inner and outer rings 34, 38 may then be even more easily dismounted from the detached front cover. In other examples, a further tool may be used to remove the first one of said radially inner and outer rings 34, 38. Such further tool may be very similar to the gripping tool 68 described above with only some slightly adapted design of the gripping surface in order to engage the first one of said radially inner and outer rings 34, 38 rather than the second one of said radially inner and outer rings 34, 38. In such further tool, the gripping surface may be in the shape of a hook portion turned radially outwardly.

With the method and tooling disclosed herein, it is possible, in the application where the cassette seal is a crankshaft cassette seal as disclosed above, to remove the cassette seal without having access from the inside of the engine casing. For example, removal of the crankshaft cassette seal can be performed without dismounting the engine oil pan 30, and in most cases also without removing the front cover 22.

The present disclosure also includes the disclosure of the following examples.

Example 1: A method (100) for dismounting a cassette seal (32) having a radially inner ring (34) mounted on a cylindrical support surface (36) of a rotative shaft (12) and having a radially outer ring (38) mounted in a cylindrical support surface (40) of a receiving static bore (24), the rotative shaft (12) being rotative around a main axis (A1) with respect to the receiving static bore (24) and the radially inner ring (34) being rotative around the main axis (A1) with respect to the radially outer ring (38), and wherein at least one of said radially inner and outer rings (34, 38) carries at least one elastomeric annular lip (54) which is biased against a contact surface of the other of said radially inner and outer rings (34, 38), characterized in that the method (100) for dismounting said cassette seal (32) includes at least :

a pressing step (200) comprising displacing a first of said radially inner and outer rings (34, 38) with respect to its respective cylindrical support surface (36, 40), along a first axial direction along the main axis (A1);

an extraction step (300), subsequent to the pressing step (200), comprising displacing the second of said radially inner and outer rings (34, 38) with respect to its respective cylindrical support surface (36, 40), along a second axial direction opposite to said first axial direction along the main axis (A1).

Example 2: The method of Example 1, wherein the pressing step (200) comprises inserting a presser tool (56) having a presser surface (54) which is angularly spread over more than 180 degrees of angle around the main axis and which is engaged axially, along the first axial direction, while being radially received between, on the one hand, the support surface (36, 40) of the first of said radially inner and outer rings (34, 38), and, on the other hand, the second of said radially inner and outer rings (34, 38), and where the presser surface (54) engages the first of said radially inner and outer rings (34, 38) to cause its displacement along the first axial direction with respect to its respective cylindrical support surface (36, 40).

Example 3: The method of Example 2, wherein the presser surface (54) of the presser tool (56) is annular and is continuous around the main axis (A1).

Example 4 : The method according to any of the preceding Examples, wherein the extraction step (300) includes inserting a gripping tool (68) having a gripping surface (70) which is angularly spread over more than 180 degrees of angle around the main axis and which is, in an engaging substep (310) of the extraction step (300), engaged axially, along the first axial direction, while being radially received between, on the one hand, the support surface (36, 40) of the first of said radially inner and outer rings (34, 38), and, on the other hand, the second of said radially inner and outer rings (34, 38), and wherein the extraction step (300) includes a retracting substep (320) which is subsequent to the engaging substep (310), in which the gripping tool (68) is retracted axially along the second axial direction, in which the gripping surface (70) engages the second of said radially inner and outer rings (34, 38), whereby the second of said radially inner and outer rings (34, 38) is displaced axially with respect to its respective cylindrical support surface (36, 40), along the second axial direction.

Example 5: The method according to Example 4, wherein, in the retracting substep (320), the gripping tool (68) is retracted axially along the second axial direction until the second of said radially inner and outer rings (34, 38) is removed from its respective cylindrical support surface (36, 40).

Example 6: The method according to any preceding example, wherein the radially inner ring (34) has an armature (42) comprising at least an inner tubular portion (44) and at least one externally oriented radial flange (46) extending externally from the inner tubular portion (44), wherein the radially outer ring (38) has an armature (48) comprising at least an outer tubular portion (50) and at least one internally oriented radial flange (52) extending internally from the outer tubular portion (50), and wherein at least one of said armatures (46, 48) carries at least one elastomeric annular lip (54) which is biased against a contact surface of the other of said armatures (46, 48).

Example 7: The method according to example 6 in combination with one of example 4 or 5, wherein during the retracting substep (320) in which the gripping tool (68) is retracted axially along the second axial direction, the gripping surface (70) engages the radial flange (46, 52) of the armature (42, 48) of the second of said radially inner and outer rings (34, 38).

Example 8: The method according to any of examples 6 or 7, wherein the radial flange (46, 52) of the armature (42, 48) of the first of said radially inner and outer rings (34, 38) is offset axially along the first direction with respect to the radial flange (46, 52) of the armature (42, 48) of the second of said radially inner and outer rings (34, 38).

Example 9: The method according to any of the preceding Examples, wherein the first of said radially inner and outer rings (34, 38) is the radially outer ring (38) and the second of said radially inner and outer rings is the radially inner ring (34).

Example 10: The method according to any of the preceding Examples, wherein the receiving static bore (24) is a through hole in a transverse wall (16, 22) of a casing (14) in which the rotative shaft (12) is received, and wherein the cylindrical support surface (36) of the rotative shaft (12) is located near an extremity (18) of the shaft (12) which extends axially through the through hole (24), outwardly of the casing (14).

Example 11: The method according to Example 10, wherein the first direction is a direction turned axially inwardly with respect to the casing (14).

Example 12: The method according to any of the preceding examples, wherein, in a removal step (400) subsequent to the extraction step (300), the first one of said radially inner and outer rings (34, 38) is removed by extracting said ring along the second direction.

Example 13: Tooling for dismounting a cassette seal (32) having an radially inner ring (34) mounted on a cylindrical support surface (36) of a rotative shaft (12) and a radially outer ring (38) mounted in a cylindrical support surface (40) of a receiving static bore (24), the rotative shaft (12) being rotative around a main axis (A1) with respect to the receiving stating bore (24) and the radially inner ring (34) being rotative around the main axis (A1) with respect to the outer ring (38), and wherein at least one of said radially inner and outer rings (34, 38) carries at least one elastomeric annular lip (54) which is biased against a contact surface of the other of said radially inner and outer rings (34, 38),

characterized in that the tooling comprises a presser surface (54) which is angularly spread over more than 180 degrees of angle around the main axis (A1) and which is configured for axially engaging the first of said radially inner and outer rings (34, 38), along the first axial direction, while being radially received between, on the one hand, the support surface (36, 40) of the first of said radially inner and outer rings (34, 38), and, on the other hand, the second of said radially inner and outer rings (34, 38).

Example 14: Tooling according to Example 13, wherein the presser surface (54) is annular and is continuous around the main axis (A1).

Example 15: Tooling according to Examples 13 or 14, wherein the presser surface (54) is part of a presser tool (56).

Example 16: Tooling according to example 15, wherein the presser tool (56) comprises a base (58) and a presser tube (60) extending axially from the base (56), the presser surface being formed at a free end of the presser tube (60).

Example 17: Tooling according to any of Examples 13 to 16, further comprising a gripping surface (70) which is angularly spread over more than 180 degrees of angle around the main axis (A1) and which is configured to be engaged axially, along the first axial direction, while being radially received between, on the one hand, the support surface (36, 40) of the first of said radially inner and outer rings (34, 38), and, on the other hand, the first of said radially inner and outer rings (34, 38), and configured such that, when the gripping surface (70) is retracted axially along the second axial direction, the gripping surface (70) engages the second of said radially inner and outer rings (34, 38).

Example 18: Tooling according to Example 17, wherein the gripping surface (70) is part of a gripping tool (68).

Example 19: Tooling according to Example 18, wherein the gripping tool (68) comprises at least three gripping fingers (72), the gripping fingers (72) being angularly spread over more than 180 degrees of angle around the main axis (A1), which extend each axially, parallel to the main axis (A1), at a same gripping circle radius distance (R) from the main axis (A1), and each gripping finger (72) having a first axial extremity and a second axial extremity (74), the second axial extremity (74) being secured to a base (76) of the gripping tool (68) and the first extremity forming a free end of the gripping finger (72), wherein the free end of gripping finger comprises an elemental gripping surface (70) turned towards the second axial extremity (74).

Example 20: Tooling according to any of Examples 18 or 19, wherein the gripping tool (68) comprises a central threaded column (80), extending along the main axis (A1), which is threaded through the base (76) of the gripping tool (68).

Example 21: Tooling to any of Examples 18 to 20 in combination with any of Examples 15 or 16, wherein the presser tool and the gripping tool are two independent tools.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A method for dismounting a cassette seal having a radially inner ring mounted on a cylindrical support surface of a rotative shaft and having a radially outer ring mounted in a cylindrical support surface of a receiving static bore, the rotative shaft being rotative around a main axis with respect to the receiving static bore and the radially inner ring being rotative around the main axis with respect to the radially outer ring, and wherein at least one of said radially inner and outer rings carries at least one elastomeric annular lip which is biased against a contact surface of the other of said radially inner and outer rings, characterized in that the method for dismounting said cassette seal includes at least :
a pressing step comprising displacing a first of said radially inner and outer rings with respect to its respective cylindrical support surface, along a first axial direction along the main axis;
an extraction step, subsequent to the pressing step, comprising displacing the second of said radially inner and outer rings with respect to its respective cylindrical support surface, along a second axial direction opposite to said first axial direction along the main axis.

2. The method of claim 1, wherein the pressing step comprises inserting a presser tool having a presser surface which is angularly spread over more than 180 degrees of angle around the main axis and which is engaged axially, along the first axial direction, while being radially received between, on the one hand, the support surface of the first of said radially inner and outer rings, and, on the other hand, the second of said radially inner and outer rings, and where the presser surface engages the first of said radially inner and outer rings to cause its displacement along the first axial direction with respect to its respective cylindrical support surface.

3. The method of claim 2, wherein the presser surface of the presser tool is annular and is continuous around the main axis.

4. The method according to claim 1, wherein the extraction step includes inserting a gripping tool having a gripping surface which is angularly spread over more than 180 degrees of angle around the main axis and which is, in an engaging substep of the extraction step, engaged axially, along the first axial direction, while being radially received between, on the one hand, the support surface of the first of said radially inner and outer rings, and, on the other hand, the second of said radially inner and outer rings, and wherein the extraction step includes a retracting substep which is subsequent to the engaging substep, in which the gripping tool is retracted axially along the second axial direction, in which the gripping surface engages the second of said radially inner and outer rings, whereby the second of said radially inner and outer rings is displaced axially with respect to its respective cylindrical support surface, along the second axial direction.

5. The method according to claim 4, wherein, in the retracting substep, the gripping tool is retracted axially along the second axial direction until the second of said radially inner and outer rings is removed from its respective cylindrical support surface.

6. The method according to claim 1, wherein the radially inner ring has an armature comprising at least an inner tubular portion and at least one externally oriented radial flange extending externally from the inner tubular portion, wherein the radially outer ring has an armature comprising at least an outer tubular portion and at least one internally oriented radial flange extending internally from the outer tubular portion, and wherein at least one of said armatures carries at least one elastomeric annular lip which is biased against a contact surface of the other of said armatures.

7. The method according to claim 6, wherein during the retracting substep in which the gripping tool is retracted axially along the second axial direction, the gripping surface engages the radial flange of the armature of the second of said radially inner and outer rings.

8. The method according to claim 6, wherein the radial flange of the armature of the first of said radially inner and outer rings is offset axially along the first direction with respect to the radial flange of the armature of the second of said radially inner and outer rings.

9. The method according to claim 1, wherein the receiving static bore is a through hole in a transverse wall of a casing in which the rotative shaft is received, and wherein the cylindrical support surface of the rotative shaft is located near an extremity of the shaft which extends axially through the through hole, outwardly of the casing.

10. The method according to claim 1, wherein, in a removal step subsequent to the extraction step, the first one of said radially inner and outer rings is removed by extracting said ring along the second direction.

11. Tooling for dismounting a cassette seal having an radially inner ring mounted on a cylindrical support surface of a rotative shaft and a radially outer ring mounted in a cylindrical support surface of a receiving static bore, the rotative shaft being rotative around a main axis with respect to the receiving stating bore and the radially inner ring being rotative around the main axis with respect to the outer ring, and wherein at least one of said radially inner and outer rings carries at least one elastomeric annular lip which is biased against a contact surface of the other of said radially inner and outer rings,
characterized in that the tooling comprises a presser surface which is angularly spread over more than 180 degrees of angle around the main axis and which is configured for axially engaging the first of said radially inner and outer rings, along the first axial direction, while being radially received between, on the one hand, the support surface of the first of said radially inner and outer rings, and, on the other hand, the second of said radially inner and outer rings.

12. Tooling according to claim 11, wherein the presser surface is annular and is continuous around the main axis.

13. Tooling according to claim 12, wherein the presser surface is part of a presser tool, and wherein the presser tool comprises a base and a presser tube extending axially from the base, the presser surface being formed at a free end of the presser tube.

14. Tooling according to claim 11, further comprising a gripping surface which is angularly spread over more than 180 degrees of angle around the main axis and which is configured to be engaged axially, along the first axial direction, while being radially received between, on the one hand, the support surface of first second of said radially inner and outer rings, and, on the other hand, the second of said radially inner and outer rings, and configured such that, when the gripping surface is retracted axially along the second axial direction, the gripping surface engages the second of said radially inner and outer rings.

15. Tooling according to claim 14, wherein the gripping surface is part of a gripping tool, wherein the gripping tool comprises at least three gripping fingers, the gripping fingers being angularly spread over more than 180 degrees of angle around the main axis, which extend each axially, parallel to the main axis, at a same gripping circle radius distance from the main axis, and each gripping finger having a first axial extremity and a second axial extremity, the second axial extremity being secured to a base of the gripping tool and the first extremity forming a free end of the gripping finger, and wherein the free end of gripping finger comprises an elemental gripping surface turned towards the second axial extremity.
